(19) United States
(12) Patent Application Publication
(10) Pub. No.: US 2024/0044080 A1
(43) Pub. Date: Feb. 8, 2024

(54) UPCYCLED CELLULOSIC FIBERS

(71) Applicant: GRASIM INDUSTRIES LIMITED, Nagda (IN)

(72) Inventors: Sharad Pandharinath Pawar, Nagda (IN); Ratnesh Uday Khanolkar, Nagda (IN); Rupesh Arun Khare, Nagda (IN); Kamlesh Jamnadas Singala, Nagda (IN); Saurabh Chandrabhan Singh, Nagda (IN); Vivek Prabhakar Khare, Nagda (IN)

(73) Assignee: GRASIM INDUSTRIES LIMITED, Nagda (IN)

(21) Appl. No.: 18/021,132

(22) PCT Filed: Jul. 22, 2021
(86) PCT No.: PCT/IB2021/056625

§ 371 Date: Feb. 13, 2023

(30) Foreign Application Priority Data
Aug. 11, 2020 (IN) 202021034374

(51) Int. Cl. D21H 13/08; D21C 5/02; D21C 9/10; D21C 9/02

(52) U.S. Cl. CPC D21H 13/08; D21C 5/02; D21C 9/1052; D21C 9/02

(57) ABSTRACT

Cellulosic material for the production of regenerated cellulosic fiber is disclosed. The cellulosic material comprises reclaimed cellulosic material, wherein the reclaimed cellulosic material is obtained from cellulosic material waste and has an intrinsic viscosity in a range of 170 ml/g to 280 ml/g. A process for preparing reclaimed cellulosic material for the production of regenerated cellulosic fiber is also disclosed.

### FIELD OF INVENTION

The present disclosure generally relates to a reclaimed cellulosic material for the production of regenerated cellulosic fiber. The present disclosure also relates to a process for preparing reclaimed cellulosic material from reclaimed cellulosic material waste such as pre-consumer textile waste material, post-consumer textile waste material comprising cotton as a major component.

### BACKGROUND

Several manmade fibers are now available in the market, that are made from cellulose-containing material. These include the viscose fibers, modal fibers, etc. Such fibers are made from dissolving grade pulp, a material is rich in cellulose obtained from wood. Since dissolving grade pulp is obtained from wood, production of such fibers may result in a negative impact on the environment due to deforestation. An alternative source of cellulose-rich material is cotton. Cotton is used for making fabrics, that are in turn made into apparels, furnishings etc. During the manufacture of apparels, a large amount of waste is generated in the form of scrap cuttings. Waste is also generated once these clothes are discarded by the users. In recent years, each person on an average is buying and discarding a larger number of clothes than ever before, resulting in the generation of a huge amount of cotton or cellulosic fiber-based textile waste in the form of both scraps of cotton material and used cotton apparel. Currently, only a fraction of cotton or cellulosic fiber-based textile is recycled. The remaining is either incinerated or ends up in landfills, thereby causing pollution.

Cotton textiles account for about one-third of the global textile production. Currently, the cotton textile is generally recycled by converting fabric into fiber form by shredding and opening. The fibers obtained by shredding are blended with other fibers or processed alone to make yarns. The process often weakens the fibers and the resultant yarn is coarser and has lower mechanical properties, thus resulting in products that are of lower quality and with more faults in yarn and fabric therefrom. Some alternate technologies are available for recycling waste, but require complex pre-treatment and conversion to a pulp. Additionally, dissolving grade pulp of high purity with low content of hemicelluloses is required along with waste cotton/cellulosic material when making regenerated cellulosic fibers. Majority of the dissolving grade pulp is made from pulp chips (softwood or hardwood) through well-established sulfite process or kraft process. In recent years a minor fraction of dissolving pulp is also made from cotton-based raw material, as an alternative source of cellulose. However, all the previously described technologies for example in U.S. Pat. No. 9,751,955 B2, US2018/0215893 and US20160369456A1 for recycling waste require complex pre-treatment and conversion to a pulp.

### SUMMARY

The disclosure provides a cellulosic material for the production of regenerated cellulosic fiber. The cellulosic material comprises reclaimed cellulosic material, wherein the reclaimed cellulosic material is obtained from cellulosic material waste and has an intrinsic viscosity in a range of 170 ml/g to 280 ml/g.

The disclosure also provides a process for preparing reclaimed cellulosic fiber for production of regenerated cellulosic fiber. The process comprises the steps in order of a) shredding cellulosic material waste; b) treating the shredded cellulosic material waste with a solution of at least one bleaching compound to reduce the degree of polymerisation of the cellulosic material waste in an aqueous solution to an intrinsic viscosity between 170 ml/g to 280 ml/g to obtain a bleached cellulosic material waste, and c) washing the bleached reclaimed cellulosic material with water to obtain reclaimed cellulosic fiber. Such reclaimed cellulosic fiber is used along with dissolving grade pulp to make viscose fiber using conventionally known process.

### BRIEF DESCRIPTION OF FIGURES

FIG. 1, illustrates a process flow of a convention viscose process.

FIG. 2, illustrates a process for the treatment of cotton waste in accordance with an embodiment.

FIG. 3, illustrates a process for the treatment of cotton waste in accordance with an embodiment.

FIG. 4, illustrates the dependence of viscose dope filterability (kw) on the viscosity of pre-treated cotton.

### DETAILED DESCRIPTION

For the purpose of promoting an understanding of the principles of the disclosure, reference will now be made to embodiments and specific language will be used to describe the same. It will nevertheless be understood that no limitation of the scope of the disclosure is thereby intended, such alterations and further modifications in the disclosed composition and method, and such further applications of the principles of the disclosure therein being contemplated as would normally occur to one skilled in the art to which the disclosure relates.

It will be understood by those skilled in the art that the foregoing general description and the following detailed description are exemplary and explanatory of the disclosure and are not intended to be restrictive thereof.

Reference throughout this specification to “one embodiment” “an embodiment” or similar language means that a particular feature, structure, or characteristic described in connection with the embodiment is included in at least one embodiment of the present disclosure. Thus, appearances of the phrase “in one embodiment”, “in an embodiment” and similar language throughout this specification may, but do not necessarily, all refer to the same embodiment.

In its broadest scope, the present application relates to cellulosic material for production of regenerated cellulosic fiber. The regenerated cellulosic fiber that may be obtained from the cellulosic material includes viscose type fiber etc.

Cellulosic material for the production of regenerated cellulosic fiber, comprising reclaimed cellulosic material, wherein the reclaimed cellulosic material is obtained from cellulosic material waste and has an intrinsic viscosity in a range of 170 ml/g to 280 ml/g.

In an embodiment, the cellulosic material for the production of regenerated cellulosic fiber further comprises virgin dissolving grade pulp having an intrinsic viscosity in the range of 400 ml/g to 550 ml/g.

In accordance with an embodiment, the cellulosic material for the production of regenerated cellulosic fiber comprises the reclaimed cellulosic material is in a range of 5% to 90%. Preferably, the reclaimed cellulosic material for the production of regenerated cellulosic fiber is in a range of 5% to 60%. The remaining amount of cellulosic material comprises dissolving grade pulp.

Reclaimed cellulosic material herein refers to waste cotton-rich fabric including pre-consumer and post-consumer waste cotton-rich fabric or cellulosic fiber or fabric waste. The pre-consumer waste fabric includes the cotton-rich fabric that is generated as scrap cutting during the manufacture of apparel, furnishing, etc. The post-consumer waste fabric includes cotton-rich fabric discarded by consumers. The cotton-rich fabrics that are discarded by consumers include both fabrics that are used by the consumers or in some cases, fabrics that are unused before being discarded by the consumers. In accordance with an aspect, the reclaimed cellulosic material comprises cotton. Preferably, cotton-rich fabric that includes at least 80% cotton or cellulosic material. More preferably, the reclaimed cellulosic material comprises at least 90% cotton or cellulosic material. Reclaimed cellulosic material herein also refers to other cotton waste materials such as dark-dyed or optical brightening agents containing cotton waste, cotton linters, comber noil, flats/carding waste.

While the fiber part of reclaimed cellulosic material should contain >80% cellulosic, the rest may be insoluble synthetics fibers. It is also possible to reclaim cellulosic material to have higher percentage of synthetic fiber for instance up to 35% of cotton or cellulosic and rest being synthetic fibers. In accordance with an embodiment, the undissolved synthetic fibers or other contaminants may be removed from the dope by filtration. The filtration may be optimized amongst many known methods with woven or non-woven screens or particle beds etc. The cleaning of filters may be carried out by manual or automated changing of screens, or back-washing, optionally with occasional scrapping or vacuum assisted removal of fibrous residue to remove the synthetic fibers efficiently. One of the ways of efficiently removing the synthetic or contaminants is through selection from filtration methodologies as defined by filtration rating, back-wash filtration system, its duration and frequency etc.

It has been reported that different cellulose source responds differently to conditions during viscose preparation. Besides higher content of alpha (higher molecular weight) cellulose, it is essential to have narrow molecular weight distribution (MWD) in viscose dope to achieve good quality viscose dope and fiber. Surprising, it is found that, though, lower molecular weight reclaimed cellulose from cotton is expected to react better with carbon disulphide, and optimal molecular weight is required to ensure good tensile properties of fiber.

The disclosure also provides a process for preparing reclaimed cellulosic material for production of regenerated cellulosic fiber. The process comprises the steps in order of a) shredding cellulosic material waste; b) treating the shredded cellulosic material waste with a solution of at least one bleaching compound to reduce the degree of polymerisation of the cellulosic material waste in an aqueous solution to an intrinsic viscosity between 170 ml/g to 280 ml/g to obtain a bleached cellulosic material waste, and c) washing the bleached reclaimed cellulosic material with water to obtain reclaimed cellulosic reclaimed cellulosic material. The reclaimed cellulosic material can be used along with dissolving grade pulp to make viscose fiber by conventional process.

In the first step of the process, the reclaimed cellulosic material is shredded, to reduce the size of the cellulosic material waste. The reclaimed cellulosic material waste is shredded to a size of less than 25 mm×25 mm to obtain shredded reclaimed cellulosic material waste. Preferably, the cellulosic material waste is shredded to a size less than 5 mm×5 mm to obtained shredded cellulosic material waste.

In the next step, the shredded cellulosic material waste is treated with a solution of at least one bleaching compound to reduce the degree of polymerisation of the cellulosic material waste in an aqueous solution. The degree of polymerisation is reduced such that the intrinsic viscosity of the cellulosic material waste is between 170 ml/g to 280 ml/g. In accordance with an embodiment, where the process is used for the preparation of cellulosic material for the viscose process, the degree of polymerization of the bleached cellulosic material waste is reduced to between 190 ml/g to 250 ml/g.

The bleaching compound is selected from a group comprising sodium hypochlorite, sodium hydrosulphite, chlorine dioxide, hydrogen peroxide or a mixture thereof. In accordance with an embodiment, the bleaching compound is hypochlorite preferably sodium hypochlorite.

The cellulosic material waste is treated for a time period of up to 4 hours and at a temperature of up to 80 degree Celsius such that the specified viscosity is obtained. In accordance with an aspect, the weight: weight ratio of cellulosic material waste to the solution of bleaching compound is in a range of 1:2 to 1:15 and the concentration of bleaching compound is in the range of 3 to 30 grams per litre (gpl). The treatment with the bleaching compound is done over a broad range of pH. In accordance with an embodiment, the treatment with the bleaching compound is done between pH 5 to 8.

In accordance with an embodiment, the pH of the solution of bleaching compound is adjusted using an acid. The acid is selected from a group comprising propionic acid, acetic acid, phosphoric acid or formic acid and their mixture thereof.

Alternatively, the cellulosic material waste is treated with acid for a time period of up to 4 hours and at a temperature of upto 60 degree Celsius such that the specified viscosity is obtained. In accordance with an aspect, the weight: weight ratio of cellulosic material waste to the acid is in a range of 1:2 to 1:15 and the concentration of acid is in the range of 100 to 600 grams per litre (gpl).

The process further comprises neutralizing the bleached cellulosic material waste to pH in the range of 7 to 12 by contacting the bleached cellulosic material waste with an aqueous caustic solution or by washing with water at a temperature of up to 90 degree. In accordance with an aspect, the weight: weight ratio of cellulosic material waste to the aqueous caustic solution is in a range of 1:2 to 1:15.

The bleached cellulosic material waste is then washed with water to remove the bleaching compound and the reaction products from the bleached cellulosic material waste. In accordance with an aspect, the bleached reclaimed cellulosic material is washed with water having a temperature in the range of 30 to 90 degree Celsius and a pH of between 4 to 8.

Excess water may then be removed from the washed cellulosic material waste. Water may be removed such that a moisture level of 40% to 50% is achieved.

The disclosure further relates to regenerated cellulosic fibers obtained from the cellulosic material as described in detail above. The regenerated cellulosic fibers include a staple fiber or filament fiber or viscose type fiber. The regenerated cellulosic fibers may be obtained from the cellulosic material, using known processes in the art. In accordance with an embodiment where the regenerated cellulosic fiber is viscose type, the intrinsic viscosity of the reclaimed cellulosic material is in the range of 190 to 250 ml/g.

It will be apparent to those skilled in the art that various modifications and variations can be made to the method/process of the present disclosure without departing from the scope of the disclosure. Other embodiments will be apparent to those skilled in the art from consideration of the specification and practice of the method/process disclosed herein. It is intended that the specification and examples be considered as exemplary only, with a true scope of the disclosure being indicated by the following claims and their equivalent.

### EXAMPLES

### Example 1: Conventional Viscose (Control)

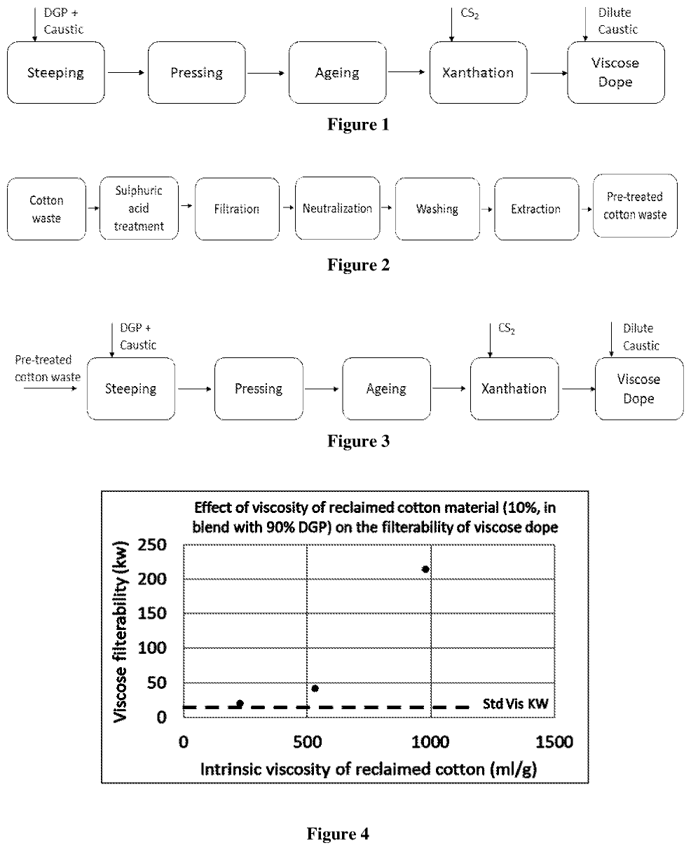

Viscose dope preparation process involves steeping of a dissolving grade pulp in 18% caustic soda solution followed by pressing and shredding to form Alkali cellulose (alkcell). The alkcell was further depolymerized, and subsequently xanthated by the addition of carbon disulfide. The cellulose xanthate was then dissolved in a caustic soda solution by mixing operation to obtain a viscose dope solution containing 9% cellulose and 5.5% caustic soda. It was prepared by the addition of 33% carbon disulfide based upon the weight of the cellulose. The viscose was then ripened for 10-12 hours. Spinning viscose is maintained at the ball fall viscosity of 60 to 90 seconds and the corresponding Gamma number was 45 to 48. Viscose filterability index (KW) was measured for the dope and observed to be 40. The process flow is described in FIG. 1.

### Example 2a-2d: Treatment of Cotton Waste: Shredding—Bleaching—Neutralization—Extraction—Washing—Extraction

Post-industrial cotton waste was shredded using a mechanical shredder to a size preferably less than 5 mm×5 mm Shredded cotton was charged into a solution containing 1.5% sodium hypochlorite and pH was adjusted to 6.5 by addition of acid (in Examples 2a and 2b: Phosphoric acid; 2c Sulphuric acid and 2d acetic acid is used). The treatment was conducted for different combinations of time and temperature as mentioned in Table 1. At the end of treatment, the pH of the solution was adjusted to 7.5 by addition of sodium hydroxide solution. A slurry of pretreated reclaimed cotton was extracted to remove water and again washed with fresh water. After washing with fresh water, the final extraction of water was carried out to achieve moisture % to a level of 40% -50%.

TABLE 1
illustrates the effect of process parameters on the viscosity
of reclaimed cotton material of examples 2a-2d.

| | | | Intrinsic viscosity of |
|---|---|---|---|
| | Temperature | | Reclaimed cotton material |
| Example | (° C.) | Time (min) | (ml/g) |
| 2a | 30 | 90 | 580 |
| 2b | 40 | 30 | 430 |
| 2c | 50 | 45 | 300 |
| 2d | 55 | 90 | 220 |

### Dope Preparation

Viscose dope preparation process involves steeping of a dissolving grade pulp in 18% caustic soda solution followed by pressing and shredding to form Alkali cellulose (alkcell). Pretreated cotton waste of different intrinsic viscosity was added along with DG pulp. The alkcell was further depolymerized, and subsequently xanthated by the addition of carbon disulfide. The cellulose xanthate was then dissolved in a caustic soda solution by mixing operation to obtain a viscose dope solution containing 9% cellulose and 5.5% caustic soda (NaOH/Cellulose ratio ˜0.56). It was prepared by the addition of 33% carbon disulfide based upon the weight of the cellulose. The viscose was then ripened for 10-12 hours. Spinning viscose is maintained at the ball fall viscosity of 40 to 90 seconds. Viscose dope filterability (KW) was measured for dope prepared using different cotton and DGP content and is tabulated in Table 2.

TABLE 2
illustrates the effect of the viscosity of reclaimed
cellulosic material on viscose dope filterability

| | Intrinsic viscosity | Reclaimed | | |
|---|---|---|---|---|
| | of Reclaimed | cellulosic | DGP | |
| | cellulosic material | material | Content | |
| Example | (ml/g) | content (%) | (%) | KW |
| 1 | — | 0% | 100% | 19 |
| 3d | 220 | 10 | 90 | 20 |
| 3e | 240 | 20 | 80 | 19 |
| 3f | 190 | 40 | 60 | 26 |
| 3g | 200 | 60 | 40 | 24 |

### Example 3(a-e): Present Invention: Cotton Recycle Content: 10%, 20% and 40%

### (i) Treatment Sequence:

Treatment with sulphuric acid—filtration—neutralization—washing with water—water extraction.

White reclaimed cotton material was pre-treated with sulphuric acid for different time periods as mentioned in table 1 to achieve different Intrinsic viscosity. After acid treatment, sulphuric acid was removed by filtration, residual sulphuric acid in cotton was neutralized using caustic solution and washed with water. After washing, cotton was pressed in a hydraulic press to obtain moisture content of 45 -50%. The process flow for the treatment of cotton waste is described in FIG. 2.

### (ii) Dope Preparation

Viscose dope preparation process involves steeping of a dissolving grade pulp in 18% caustic soda solution followed by pressing and shredding to form Alkali cellulose (alkcell). Reclaimed cellulosic material of different intrinsic viscosity was added along with DG pulp. The alkcell was further depolymerized, and subsequently xanthated by the addition of carbon disulfide. The cellulose xanthate was then dissolved in a caustic soda solution by mixing operation to obtain a viscose dope solution containing 9% cellulose and 5.5% caustic soda (NaOH/Cellulose ratio ˜0.56). It was prepared by the addition of 33% carbon disulfide based upon the weight of the cellulose. The viscose was then ripened for 10-12 hours. Spinning viscose is maintained at the ball fall viscosity of 40 to 90 seconds. Viscose filterability (KW) was measured for dope prepared using different viscosity cotton and is tabulated in Table 3. The process flow is corresponding to example 2b and 2c are described in FIG. 3. FIG. 4 describes the dependence of viscose dope filterability (kw) on the viscosity of pre-treated cotton.

TABLE 3
illustrates the effect of process parameters
on the viscosity of reclaimed cotton

| | | Treatment | Intrinsic viscosity |
|---|---|---|---|
| Sulphuric acid | Treatment time | Temperature | of Reclaimed cotton |
| concentration (%) | (min) | (° C.) | (ml/g) |
| Not Treated | Not treated | Not Treated | 980 |
| 50 | 60 | 25 | 533 |
| 40 | 30 | 35 | 389 |
| 45 | 30 | 40 | 228 |
| 50 | 15 | 45 | 217 |
| 45 | 60 | 50 | 130 |

TABLE 4
Effect of the viscosity of reclaimed cotton
material on viscose dope filterability

| | Reclaimed | Reclaimed | | |
|---|---|---|---|---|
| | Cotton material | Cotton | | |
| | Intrinsic | material | Virgin DGP | |
| Example | Viscosity (ml/g) | content (%) | content (%) | KW |
| 1 | — | 0% | 100% | 19 |
| 3a | 980 | 10% | 90% | 214 |
| 3b | 533 | 10% | 90% | 42 |
| 3c | 228 | 10% | 90% | 20 |
| 3d | 217 | 20% | 80% | 20 |

Specific embodiments are hereinafter described:

Cellulosic material for the production of regenerated cellulosic fiber, comprising reclaimed cellulosic material, wherein the reclaimed cellulosic material is obtained from cellulosic material waste and has an intrinsic viscosity in a range of 170 ml/g to 280 ml/g.

Such cellulosic material for the production of regenerated cellulosic fiber, further comprising virgin dissolving grade pulp having an intrinsic viscosity in the range of 400 ml/g to 550 m/g.

Such cellulosic material for the production of regenerated cellulosic fiber, wherein the reclaimed cellulosic material is in a range of 5% to 90%.

Such cellulosic material for the production of regenerated cellulosic fiber, wherein the reclaimed cellulosic material is obtained from cellulosic material waste comprising cotton of cellulosic material selected from pre-consumer cotton-rich fabric waste, post-consumer cotton-rich fabric waste and cellulosic fiber.

Regenerated cellulosic fibers obtained from such cellulosic material wherein the regenerated cellulosic fibers is a staple fiber or filament fiber of viscose type.

Such regenerated cellulosic fiber, wherein the intrinsic viscosity of the reclaimed cellulosic material is in the range of 190 to 250 ml/g for viscose type.

Further, specific embodiments are hereinafter described:

A process for preparing reclaimed cellulosic material for the production of regenerated cellulosic fiber, comprising the steps of: a)shredding cellulosic material waste; b) treating the shredded cellulosic material waste with a solution of at least one bleaching compound to reduce the degree of polymerisation of the cellulosic material waste in an aqueous solution to an intrinsic viscosity between 170 ml/g to 280 ml/g to obtain a bleached cellulosic material waste; and c) washing the bleached reclaimed cellulosic material with water to obtain reclaimed cellulosic fiber.

Such process(es), wherein the reclaimed cellulosic material waste is selected from pre-consumer or post-consumer cotton-rich fabric waste, or cellulosic fiber comprising cotton or cellulosic material.

Such process(es), wherein the bleaching compound is selected from a group comprising sodium hypochlorite, sodium hydrosulphite, chlorine dioxide, hydrogen peroxide or their mixtures thereof.

Such process(es), wherein the cellulosic material waste is treated with the bleaching compound for a time period of up to 4 hours, at a temperature of up to 80 degree Celsius.

Such process(es), wherein the weight: weight ratio of cellulosic material waste to the bleaching solution is in a range of 1:2 to 1:15.

Such process(es), wherein the concentration of the bleaching reagent is in the range of 3 to 30 grams per litre of water.

Such process(es), further comprising adjusting the pH of the solution of bleaching compound to pH 5 to 8 using an acid.

Such process(es), wherein said acid is selected from a group comprising propionic acid, acetic acid, phosphoric acid or formic acid and their mixtures thereof.

Such process(es), wherein, the bleached reclaimed cellulosic material waste is neutralized with aqueous caustic solution.

Such process(es), wherein the neutralisation in step is performed at a pH in the range of 7 to 12.

Such process(es), wherein the degree of polymerization of the bleached cellulosic material waste is reduced to an intrinsic viscosity between 190 ml/g to 250 ml/g for the viscose process.

### INDUSTRIAL APPLICABILITY

The cellulosic material, as disclosed provides an alternative raw material for the production of regenerated cellulosic fiber. The cellulosic material is obtained from waste cotton material produced during the production of apparels, furnishings etc., as well as those waste cotton material discarded by the consumer. As it has higher degree of polymerisaton the cellulosic material as disclosed allows for efficient recycling of the waste cotton material.

Further, the process as disclosed allows for the recycling of waste cotton rich material such as scraps and used clothes in an easy and efficient matter. The process allows for the simpler conversion of post-industrial cotton waste into ready-to-use raw material for the viscose. The process converts multiple coloured cotton waste into cellulosic material that can be used in the production of regenerated cellulosic fibers in a simple manner.

1. Cellulosic material for the production of regenerated cellulosic fiber, comprising reclaimed cellulosic material, wherein the reclaimed cellulosic material is obtained from cellulosic material waste and has an intrinsic viscosity in a range of 170 ml/g to 280 ml/g.

2. Cellulosic material for the production of regenerated cellulosic fiber as claimed in claim 1, further comprising virgin dissolving grade pulp having an intrinsic viscosity in the range of 400 ml/g to 550 m/g.

3. Cellulosic material for the production of regenerated cellulosic fiber as claimed in claim 1, wherein the reclaimed cellulosic material is in a range of 5% to 90%.

4. Cellulosic material for the production of regenerated cellulosic fiber as claimed in claim 1, wherein the reclaimed cellulosic material is obtained from cellulosic material waste comprising cotton selected from pre-consumer cotton-rich fabric waste, post-consumer cotton-rich fabric waste and cellulosic fiber.

5. Regenerated cellulosic fibers obtained from the cellulosic material as claimed in claim 1, wherein the regenerated cellulosic fiber is a staple fiber or filament fiber of viscose type.

6. Regenerated cellulosic fiber as claimed in claim 5, wherein the intrinsic viscosity of the reclaimed cellulosic material is in the range of 190 to 250 ml/g for viscose type.

7. A process for preparing reclaimed cellulosic material for the production of regenerated cellulosic fiber, comprising the steps of:
a. shredding cellulosic material waste;
b. treating the shredded cellulosic material waste with a solution of at least one bleaching compound to reduce the degree of polymerisation of the cellulosic material waste in an aqueous solution to an intrinsic viscosity between 170 ml/g to 280 ml/g to obtain a bleached cellulosic material waste; and
c. washing the bleached reclaimed cellulosic material with water to obtain reclaimed cellulosic fiber.

8. The process as claimed in claim 7, wherein the reclaimed cellulosic material waste is selected from pre-consumer or post-consumer cotton-rich fabric waste, or cellulosic fiber comprising cotton or cellulosic material.

9. The process as claimed in claim 7, wherein the bleaching compound is selected from a group comprising sodium hypochlorite, sodium hydrosulphite, chlorine dioxide, hydrogen peroxide or their mixtures thereof.

10. The process as claimed in claim 7, wherein the cellulosic material waste is treated with the bleaching compound for a time period of up to 4 hours, at a temperature of up to 80 degree Celsius.

11. The process as claimed in claim 7, wherein the weight: weight ratio of cellulosic material waste to the bleaching solution is in a range of 1:2 to 1:15.

12. The process as claimed in claim 7, wherein the concentration of the bleaching reagent is in the range of 3 to 30 grams per litre of water.

13. The process as claimed in claim 7, further comprising adjusting the pH of the solution of bleaching compound to pH 5 to 8 using an acid.

14. The process as claimed in claim 13, wherein said acid is selected from a group comprising propionic acid, acetic acid, phosphoric acid or formic acid and their mixtures thereof.

15. The process as claimed in claim 13, wherein, the bleached reclaimed cellulosic material waste is neutralized with aqueous caustic solution.

16. The process as claimed in claim 13, wherein the neutralisation in step is performed at a pH in the range of 7 to 12.

17. The process as claimed in claim 7, wherein the degree of polymerization of the bleached cellulosic material waste is reduced to an intrinsic viscosity between 190 ml/g to 250 ml/g for the viscose process.
